(19) United States
(12) Patent Application Publication
(10) Pub. No.: US 2011/0101124 A1
(43) Pub. Date: May 5, 2011

(54) HURRICANE ABATEMENT SYSTEM AND METHOD

(76) Inventor: David A. Roberts, Gloucester, VA (US)

(21) Appl. No.: 12/839,537

(22) Filed: Jul. 20, 2010

Related U.S. Application Data
(60) Provisional application No. 61/226,856, filed on Jul. 20, 2009.

(51) Int. Cl. A01G 15/00

(52) U.S. Cl. 239/14.1

(57) ABSTRACT

A system for hurricane abatement which cools air above a water body surface of a water body which includes a large number of relatively small pumps dispersed over a wide area of a water body. The pumps are shaped and dimensioned for pumping water from a depth of the water body into air above the water body surface thereby cooling the air above the water body surface. The pumps are deployed in lots of approximately 1 pump per square mile (2.59 square kilometers) over a 100 miles squared (25900 square kilometers) area ahead of a projected path of a hurricane. The method includes the steps of determining requirements necessary to properly abate a hurricane, pumping water from depths of a water body into an area directly above a water body surface of the water body and along the projected path of the hurricane, thereby cooling the air along the path of the projected path of the hurricane, and diminishing power of the hurricane as it passes through the cooled air above the water body surface.

### CROSS REFERENCE TO RELATED APPLICATIONS

This application claims the benefit of U.S. Provisional Patent Application Ser. No. 61/226,856, entitled “HURRICANE ABATEMENT SYSTEM AND METHOD”, filed Jul. 20, 2009.

### BACKGROUND OF THE INVENTION

1. Field of the Invention

The invention relates to hurricane abatement. More particularly, the invention relates to a system which seeks to reduce the force and/or guide the path of hurricanes by using wave-powered pumps to spray cooler sea water from ocean depth into the air above the ocean and thus cool the air above the ocean ahead of the hurricane track, in what is herein described as the “ocean/hurricane interface zone”.

2. Description of the Related Art

Hurricanes are known to cause great hardship for people living along the eastern seaboard of the United States. As such, much attention has been directed to both predicting the path of these hurricanes and developing mechanisms for controlling these hurricanes or at least diminishing their power.

It is generally agreed that hurricanes strengthen in regions of the ocean where the water is warm. Also, it is well known that either cold water or a cold weather front substantially dissipates or reduces the strength of a hurricane. In the case of a hurricane, reducing the surface water temperature by approximately 1-5 degrees Celsius will substantially impact a hurricane in a positive way by reducing or diffusing its strength. However, the density of water, and the volume of water which must be cooled to produce even a negligible effect upon a hurricane, has led to limited success in hurricane abatement through the cooling of ocean water.

As such, systems for hurricane abatement are still needed and the present invention provides such a system.

### SUMMARY OF THE INVENTION

It is, therefore, an object of the present invention to provide a system for hurricane abatement which cools air above a water body surface of a water body. The system includes a large number of relatively small pumps dispersed over a wide area of a water body. The pumps are shaped and dimensioned for pumping water from a depth of the water body into air above the water body surface thereby cooling the air above the water body surface. The pumps are deployed in lots of approximately 1 pump per square mile (2.59 square kilometers) over a 100 miles squared (25,900 square kilometers) area ahead of a projected path of a hurricane.

It is also an object of the present invention to provide a system wherein the pumps are wave-powered pumps.

It is another object of the present invention to provide a system wherein each of the wave-powered pumps is composed of an extending tube and a pressure cylinder, the extending tube and pressure cylinder interacting with the assistance of wave motion to pressurize water held within the extending tube and pump water out of a dispensing end and into the air above the water body surface.

It is a further object of the present invention to provide a system wherein the extending tube includes a lower, first end which is positioned at a desired depth within the water body and an upper, second end from which the pressurized water is pumped upwardly into the atmosphere above the water body surface.

It is also an object of the present invention to provide a system wherein the first end of the extending tube includes a down weight for holding the extending tube at a desired location within the water body.

It is another object of the present invention to provide a system wherein the first end of the extending tube includes a filter.

It is a further object of the present invention to provide a system wherein the extending tube includes an inflatable tube adjacent the second end supporting the second end of the extending tube above the water body surface.

It is also an object of the present invention to provide a system wherein the second end of the extending tube includes a stand pipe and a nozzle.

It is another object of the present invention to provide a system wherein the extending tube includes piston rod and the pressure cylinder interacts therewith for creating pressure causing dispensing of water from the second end of the extending tube.

It is a further object of the present invention to provide a system including a piston that is fixedly secured to the piston rod at a central position along the piston rod, the piston being shaped and dimensioned for positioning within a central cavity defined by the pressure cylinder.

It is also an object of the present invention to provide a system further including a permanent pumping system composed of a land-based pumping station linked to a plurality of spray assemblies defining passageways for forcing water upwardly to the water body surface where it is sprayed into the air directly above the water body surface.

It is another object of the present invention to provide a system wherein each of the spray assemblies includes a hose to which an inflatable member is positioned at a distal end thereof such that a spray nozzle at a second end of the hose sits above the water body surface for spraying water to a desired height above the water body surface.

It is a further object of the present invention to provide a system wherein water is sprayed to a height of about 30 feet (9.14 meters) into the air.

It is also an object of the present invention to provide a system wherein the spray of water reduces the air temperature in the air directly above the water body surface by approximately 1° Fahrenheit (0.55° Celsius) up to approximately 10° Fahrenheit (5.55° Celsius).

It is another object of the present invention to provide a method for hurricane abatement including the steps of determining requirements necessary to properly abate a hurricane, pumping water from depths of a water body into an area directly above a water body surface of the water body and along the projected path of the hurricane, thereby cooling the air along the path of the projected path of the hurricane, and diminishing power of the hurricane as it passes through the cooled air above the water body surface.

It is a further object of the present invention to provide a method wherein the step of pumping includes spraying the water to a height of about 30 feet (9.14 meters) into the air.

It is also an object of the present invention to provide a method wherein the spray of water reduces air temperature in the air directly above the water body by approximately 1° Fahrenheit (0.55° Celsius) up to approximately 10° Fahrenheit (5.55° Celsius).

It is another object of the present invention to provide a method including the step of positioning a plurality of multiple lots of approximately 1 pump per square mile (2.59 square kilometers) over a 100 miles squared (25,900 square kilometers) area ahead of a projected path of a hurricane.

It is a further object of the present invention to provide a method wherein the step of positioning includes delivering the pumps via aircraft.

It is also an object of the present invention to provide a method wherein the pumps are wave-powered pumps.

It is another object of the present invention to provide a method wherein the pumps are powered by a permanent land-based pumping system.

It is a further object of the present invention to provide a method including the step of steering the hurricane.

It is another object of the present invention to provide a method wherein the step of steering includes cooling the air directly above the water body surface at positions to the left or the right of the projected path of the hurricane.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic showing implementation of the present hurricane abatement system.

FIG. 2 is a side schematic view showing a hurricane approaching cool air in accordance with the present invention.

FIG. 3 is a side schematic view of a pump in accordance with a preferred embodiment of the present invention.

FIG. 4 is a schematic view of a pumping system in accordance with an alternate embodiment of the present invention.

FIG. 5 is a schematic showing implementation of the present hurricane abatement system in accordance with an alternate embodiment thereof.

FIG. 6 is a satellite image of Hurricane Mitch 1998, with annotation showing implementation of the present system.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

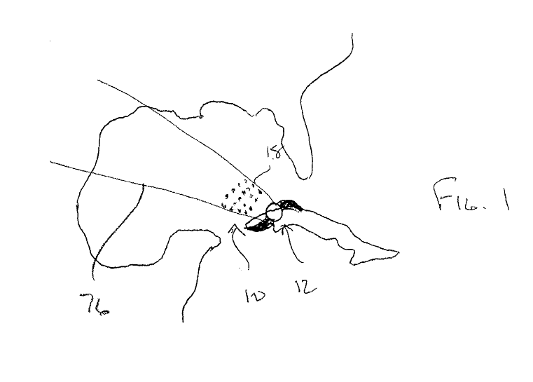

In accordance with the present invention, and with reference to FIGS. 1 to 3, a system 10 for hurricane abatement is disclosed. In accordance with a first embodiment, the present hurricane abatement system 10 is designed to slow the progression of a hurricane 12 by pumping cooler water from the depths of the ocean 13, or other water body, into the area directly above the water body surface 16 and along the path of a hurricane 12. The area directly above the water body surface 16 and along the projected path 76 of a hurricane 12 is defined herein as the water body/hurricane interface zone 14 and represents a body of air, which when cooled in accordance with the present invention, acts to reduce the strength of a hurricane passing thereby.

Although the term “ocean” is used herein in describing preferred embodiments of the present invention, the present hurricane abatement system may be employed in a variety of water bodies within the spirit of the present invention. In addition, although the present invention is particularly designed for use in the abatement of hurricanes it is contemplated the concepts underlying the present invention may be employed in affecting other weather patterns.

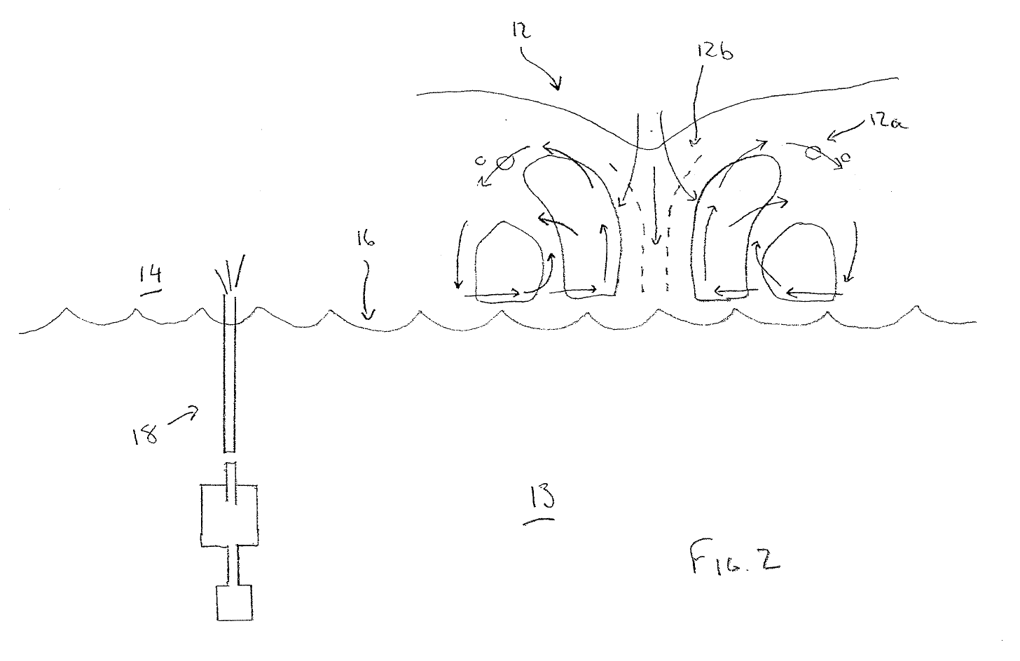

By cooling the air directly above the water body surface 16 along the projected path 76 of a hurricane 12 in accordance with the present invention, the power of the hurricane 12 is abated. A hurricane 12 gains its strength by absorbing heat and moisture from the ocean 13 over a wide area. Referring to FIG. 2, it is commonly understood that hurricanes 12 form when the energy released by the condensation of the moisture in rising air 12a causes a chain reaction. The air heats up, rising further, which leads to more condensation. The air flowing out of the top of this “chimney” 12b (see the central passageway with the air flowing upward as shown in FIG. 2) drops toward the ground or water body surface 16, forming powerful winds. Introducing cooler air at the base of the hurricane 12, that is, at the water body/hurricane interface 14, in accordance with the present invention short-circuits this process, reducing the force of the hurricane 12. That is, the cooler air at the water body/hurricane interface 14 will in effect place a brake on the air flow by preventing the pick-up of the warm moist air which fuels the rotation of the hurricane 12, resulting in a slow down in the rotation of the hurricane 12. Since it is not feasible to actually cool ocean water itself sufficiently to have an effect upon a hurricane 12 passing thereby, the present invention cools the air directly above the surface 16 of the water body 13 (that is, at the water body/hurricane interface zone 14) through the application of a large number of relatively small pumps 18 dispersed over a wide area.

More particularly, because water is about 800 times denser than air, it is far more difficult to cool water than to cool air. Thus, by cooling the air above the water body surface 16 at the water body/hurricane interface 14 in accordance with the present invention instead of the surface 16 of the water body 13, one is able to have about 800 times greater cooling effect for whatever pumping action is undertaken, and the pumping of the cooler water to the water body/hurricane interface zone 14 above the water body surface 16 results in a greater effect upon the hurricane 12 itself.

The following chart (Table 1) shows the difference in water temperature as one moves deeper and deeper into the ocean 13. As those skilled in the art will certainly appreciate, by pumping the cooler water upwardly and into the air directly above the water body surface 16 of the ocean 13, that is, into the water body/hurricane interface zone 14, the air is cooled. The deeper from which the water is drawn, the cooler the water pumped to the surface will be. With that in mind, and considering the various pumping systems disclosed in accordance with the present invention, the depth from which the water is drawn will ultimately be determined based upon a cost-benefit analysis.

TABLE 1

| | | | Depth water | Temp | |
|---|---|---|---|---|---|
| Date/Time | Latitude | Longitude | [m] | [deg C.] | Label |
| 1990-06-10T00:00 | 26.2000 | −70.3833 | 0 | 27.10 | 786671 |
| 1990-06-10T00:00 | 26.2000 | −70.3833 | 11 | 27.07 | 786671 |
| 1990-06-10T00:00 | 26.2000 | −70.3833 | 19 | 26.78 | 786671 |
| 1990-06-10T00:00 | 26.2000 | −70.3833 | 40 | 24.96 | 786671 |
| 1990-06-10T00:00 | 26.2000 | −70.3833 | 46 | 24.70 | 786671 |
| 1990-06-10T00:00 | 26.2000 | −70.3833 | 57 | 23.98 | 786671 |
| 1990-06-10T00:00 | 26.2000 | −70.3833 | 78 | 22.85 | 786671 |
| 1990-06-10T00:00 | 26.2000 | −70.3833 | 95 | 22.37 | 786671 |
| 1990-06-10T00:00 | 26.2000 | −70.3833 | 107 | 21.83 | 786671 |
| 1990-06-10T00:00 | 26.2000 | −70.3833 | 112 | 21.48 | 786671 |
| 1990-06-10T00:00 | 26.2000 | −70.3833 | 131 | 20.77 | 786671 |
| 1990-06-10T00:00 | 26.2000 | −70.3833 | 138 | 20.75 | 786671 |
| 1990-06-10T00:00 | 26.2000 | −70.3833 | 146 | 20.27 | 786671 |
| 1990-06-10T00:00 | 26.2000 | −70.3833 | 157 | 19.82 | 786671 |
| 1990-06-10T00:00 | 26.2000 | −70.3833 | 193 | 19.07 | 786671 |
| 1990-06-10T00:00 | 26.2000 | −70.3833 | 361 | 17.64 | 786671 |
| 1990-06-10T00:00 | 26.2000 | −70.3833 | 399 | 17.27 | 786671 |
| 1990-06-10T00:00 | 26.2000 | −70.3833 | 427 | 16.80 | 786671 |
| 1990-06-10T00:00 | 26.2000 | −70.3833 | 463 | 16.62 | 786671 |

Hurricanes are very big and powerful and substantial effort to alter the physical characteristics must be applied in order to have any effect. However, by cooling the air above the water body surface 16 of the ocean 13 along the water body/hurricane interface zone 14, and thereby improving the efficiency of cooling by a multiple of about 800, the present invention provides enough cooling to have an effect upon the hurricane 12 itself.

In accordance with a preferred embodiment, lots of approximately 10,000 small wave-powered pumps 18 (about 50 gallon (189.3 liters) cylinder size) are positioned and deployed in multiple lots of approximately 1 pump per square mile (2.59 square kilometers) over a 100 miles squared, that is, 10,000 square miles, (25,900 square kilometers) area ahead of the projected path 76 of a hurricane 12. Although it is contemplated a density of 1 pump per square mile (2.59 square kilometers) is believed to be sufficient to abate a hurricane in accordance with the present invention, greater or fewer pumps may be necessary as the concepts underlying the present invention are further studied and evaluated. While the present disclosure focuses upon a single application along the projected path 76 of a hurricane 12, the process of positioning pumps 18 along the path of a hurricane 12 may be repeated as needed several times as the hurricane 12 advances. The wave-powered pumps 18 are preferably ship delivered before the hurricane season and anchored within the continental shelf in areas likely to be in the projected path 76 of the hurricane 12.

Similarly, and in accordance with an alternate preferred embodiment, or as a supplement to the ship delivery of wave-powered pumps 18, the wave-powered pumps 18 may be air dropped by C-130 type aircraft in deeper ocean areas or areas not covered by pre-positioned ship delivered anchor pumps 18. A C-130 type aircraft would be able to carry about 45 wave-powered pumps 18 of the anticipated design, so flying 2 or 3 missions a day (depending upon range) about 110 C-130 type aircrafts would be able to deliver about 10,000 wave-powered pumps 18 in a day and this could be repeated as needed in subsequent days as the hurricane 12 advances. In accordance with such an embodiment, it is contemplated the wave-powered pumps 18 would be air dropped in desired locations approximately 24 hours ahead of the projected path 76 of the hurricane 12.

Regardless of whether the wave-powered pumps 18 are ship delivered, air dropped, or otherwise delivered to their desired locations, the environmental impact is reduced by only using the wave-powered pumps 18 during hurricane season and then recovering the wave-powered pumps 18. In accordance with the desire for recovery of the pumps 18, the pumps 18 are provided with beacon locators 70 allowing for ready pick-up of the pumps 18 after they are no longer needed. It is contemplated the pumps 18 would be picked-up either by boats passing through the affected territory or by helicopters sent out to retrieve the pumps 18 based upon the information provided by the beacon locators 70.

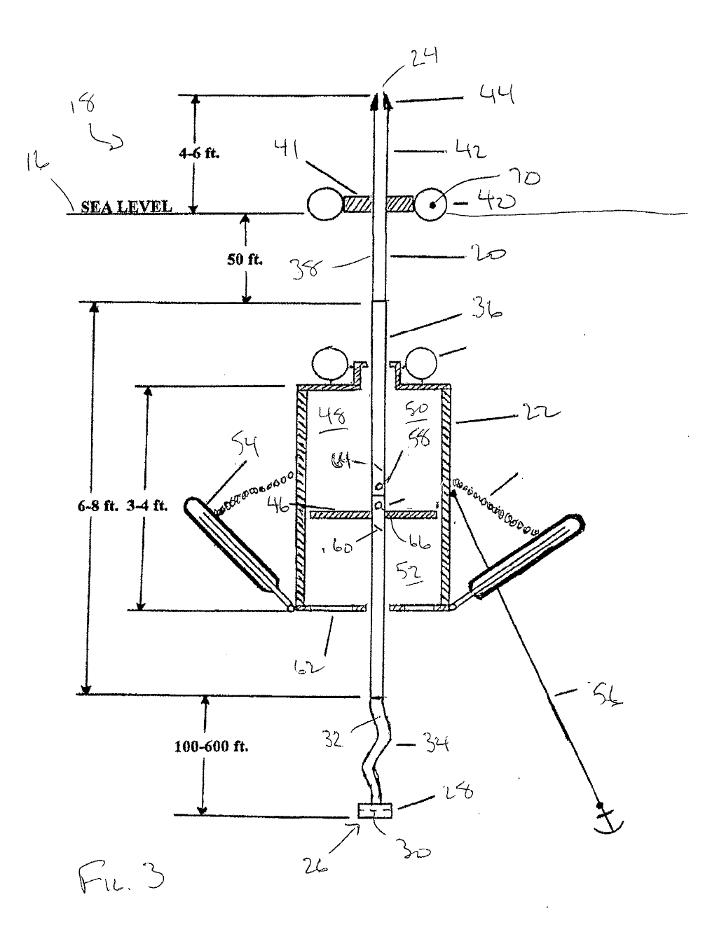

Referring to FIG. 3, a wave-powered pump 18 for use in accordance with the present invention is disclosed. Although a preferred pump is disclosed in accordance with a preferred embodiment of the present invention, is contemplated a variety of pumps may be used in the implementation of the present invention without departing from the spirit of the present invention. The wave-powered pump 18 is generally composed of a centrally extending tube 20 and a pressure cylinder 22. The centrally extending tube 20 and pressure cylinder 22 interact with the assistance of wave motion to pressurize water held within the centrally extending tube 20 and pump the water out of the dispensing end 24 and into the air adjacent the water body surface 16, that is, the water body/hurricane interface zone 14.

The centrally extending tube 20 includes a lower, first end 26 which is positioned at a desired depth within the water body 13 and an upper, second end (or dispensing end) 24 from which the pressurized water is pumped upwardly into the atmosphere above the water body surface 16. The first end 26 includes a down weight 28 for holding the centrally extending tube 20 at a desired location within the water body 13 and a filter 30 ensuring that fish, debris, and other articles do not enter the lumen 32 of the centrally extending tube 20. Extending upwardly from the down weight 28 and filter 30 is a down hose 34. The down hose 34 extends upwardly to a piston rod 36, which specifically interacts with the pressure cylinder 22 to create the pressure necessary in expelling deep, cold ocean water from the dispensing end 24 of the centrally extending tube 20.

Extending upwardly from the piston rod 36, the centrally extending tube 20 includes a cable and hose 38, an inflatable tube 40 connected to the centrally extending tube 20 by a hub 41 for supporting the dispensing end 24 above the surface 16 of the water body 13, a stand pipe 42 and a nozzle 44 at the dispensing end 24 of the centrally extending tube 20.

Although water enters the present wave-powered pumps 18, in particular, the centrally extending tube 20, at the down weight 28 and filter 30, the interaction between the pressure cylinder 22 and the piston rod 36 creates the internal pressure needed to force the water from the dispensing end 24 with sufficient force to cool the air directly above the water body surface 16. With this in mind, the piston rod 36 is provided with a piston 46 that is fixedly secured to the piston rod 36 at a central position along the piston rod 36. The piston 46 is shaped and dimensioned for positioning within the central cavity 48 defined by the pressure cylinder 22. The piston 46 creates an upper, first pressure chamber 50 and a lower, second pressure chamber 52 above and below the piston 46.

As such, when a wave moves across the dispensing end 24 of the centrally extending tube 20 causing the centrally extending tube 20 to be lifted upwardly, the piston rod 36 and piston 46 are lifted upwardly within the pressure cylinder 22 that is held in a static position by either or both of a pair of paddles 54 and/or an anchor 56. Assuming the space between the piston 46 and the first pressure chamber 50 of the pressure cylinder 22 is fully loaded with water, the upward movement of the piston 46 causes water to be forced into the lumen 32 of the centrally extending tube 20 through an inlet hole 58 formed in the piston rod 36. The pressure created by the loaded water being forced from the pressure cylinder 22 will cause a spray of water to be created from the dispensing end 24 of the centrally extending tube 20. The water forced into the centrally extending tube 20 during the upward stroke of the piston 46 functions to pressurize the centrally extending tube 20 for pumping since a lower check valve 60 prevents water from being forced downwardly within the centrally extending tube 20.

As the piston 46 is moved downwardly, water is drawn upwardly from the first end 26 of the centrally extending tube 20 and into the first pressure chamber 50 defined by the piston 46 and the pressure cylinder 22. Downward movement of the piston 46 is facilitated by openings 62 formed in the bottom of the pressure cylinder 22 allowing for displacement of water held in the second pressure chamber 52. As the piston 46 moves downwardly a vacuum is created within the first pressure chamber 50. The vacuum causes water to be drawn from the first end 26 of the centrally extending tube 20 through the filter 30 and down hose 34, and into the first pressure chamber 50. The vacuum draw of water in this manner is facilitated by the position of an upper check valve 64, which allows the flow of water or air from the inlet hole 58 to the dispensing end 24, but prevents the draw of water or air from above the piston rod to the first pressure chamber 50. Similarly, an outlet hole 66 permits the flow of water or air from the first end 26 of the centrally extending tube 20 to the first pressure chamber 50 and prevents the flow of water and air from the first pressure chamber 50 to the first end 26 of the centrally extending tube 20. The cycle is repeated as the waves move over the pump.

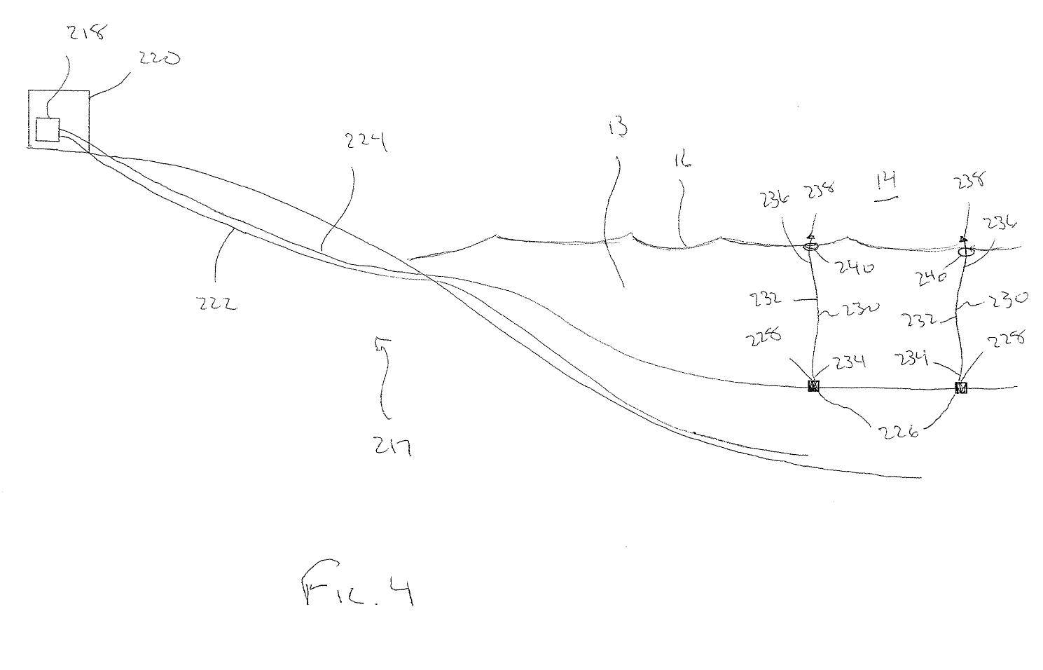

In addition to either the ship delivered wave-powered pumps 18 or the air dropped wave-powered pumps 18, a shore-based permanent pumping system 217 is contemplated for use in accordance with the present invention. As with the previously discussed pumps, and with reference to FIG. 4, the permanent pumping system 217 is used in pumping water above the surface 16 of the water body 13. In particular, a plurality of pumping systems 217 are preferably positioned along the coastline and directed outwardly into the water body 13. Using high-powered, land (or shore)-based pumps 218 and fluid dynamic principles, adequate pressure could be generated to create a spray of water to a level sufficient for cooling the air in the water body/hurricane interface zone 14 in accordance with the present invention.

In particular, and with reference to FIG. 4, a land-based pumping station 220 housing a pump 218 (either electrically or gas powered) is positioned along the coastline. As discussed above, multiple pumping stations 220 could be built and maintained along the coastline at locations deemed to warrant the expense of building and maintaining the pumping stations 220.

In accordance with a preferred embodiment, the pump 218 of the pumping station 220 includes an intake line 222 extending into the water body 13 to a depth sufficient to pull cool water from the floor of the water body 13. The pump 218 draws the cool water in and pumps it outwardly along an output line 224. The output line 224 includes a series of junction boxes 226 positioned at various locations within the ocean. The junction boxes 226 are preferably located approximately 300 feet (91.44 meters) to 500 feet (152.4 meters) beneath the surface 16 of the water body 13 and positioned approximately 1 mile (1.69 kilometers) apart. Each junction box 226 includes an upwardly directed outlet 228 connected to a spray assembly 230. The spray assembly 230 defines a passageway for forcing water upwardly to the surface 16 of the water body 13 where it is sprayed into the water body/hurricane interface zone 14 in accordance with the present invention. In accordance with a preferred embodiment, the spray assembly 230 includes a flexible, tubular hose 232 shaped and dimensioned for the pumping of a desired quantity of water to the surface 16 of the water body 13. The tubular hose 232 includes a first end 234 connected to the outlet 228 of the junction box 226 and a free second end 236 to which a spray nozzle 238 is secured for the distribution of water being sprayed into the water body/hurricane interface zone 14. The spray nozzle 238 is maintained at the water body surface 16 by positioning an inflatable member 240 about the distal end 242 of the hose 232 adjacent to the second end 236 thereof but proximal to the spray nozzle 238 such that the spray nozzle 238 sits above the surface 16 of the water body 13 so that the spray of cool water would effectively rise to a desired height above the water body surface 16 for cooling of water body/hurricane interface zone 14.

It is contemplated such an arrangement, although requiring substantial initial capital investment, would be rather self-sufficient over the long run and require minimal replacement of parts which might easily be replaced on an individual basis as the parts break. It is further contemplated, the effectiveness of such a system as it relates to cost will largely be dictated by the extent of the continental shelf and the distance to which the system must be extended to obtain water of a desired cooling capacity.

Although dimensions are provided in conjunction with the embodiments of the pumps described above, it is contemplated these dimensions may be altered depending upon the depth to which the pump is intended to be utilized. In addition, and although a preferred pump is disclosed in accordance with the present invention, it is contemplated other pump structures may be utilized in conjunction with the present invention without departing from the spirit thereof.

Because hurricane dynamics are extremely complex, it is contemplated computer modeling will be applied in determining the requirements necessary to properly abate a hurricane 12 in accordance with the present invention. In accordance with a preferred embodiment, it is contemplated the pumps 18 would be delivered to their desired locations approximately 24 hours before the hurricane 12 is anticipated to be arriving at the locations based upon the projected path 76 of the hurricane 12.

As discussed above, the present invention abates the force of hurricanes 12 by utilizing wave-powered pumps 18 to spray cooler seawater from water body 13 depths into the air above the water body 13, that is, along the water body/hurricane interface zone 14. By cooling the air directly above the water body surface 16 and directly along the line of the projected path 76 of the hurricane 12, the hurricane's power is diminished as it passes through the water body/hurricane interface zone 14.

With the pumps 18 dispersed within the water body 13 in accordance with the present invention, and once a projected path 76 of the hurricane 12 is identified, the pumps 18 function to cool the air in the area directly ahead of the moving hurricane 12.

In accordance with an alternate embodiment, it is contemplated that a hurricane 12 could be steered by utilizing the present system 10. Where one desires to steer the hurricane 12, the pumps 18 would be positioned to the left or the right of the projected path 176 of the hurricane 112 and would thus produce a steering effect upon the hurricane 112.

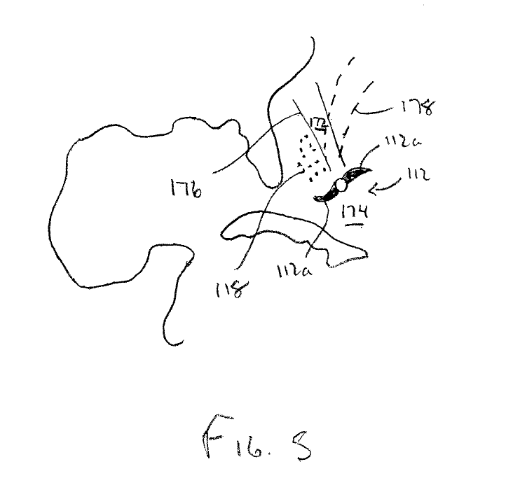

In particular, and with reference to FIG. 5, it is understood that rotation of a hurricane 112 is the result of the arms 112a of the hurricane 112 turning toward the warm water 172 in front of the hurricane 112 and away from the cold water 174 left by the hurricane 112 as it passes over the water body 13. As such, if one were to cool the surface air 114 to the left (or right) of the projected hurricane path 176 in accordance with the present invention, the hurricane 112 would steer away from the cool surface air 114 produced in accordance with the present invention and toward the warmer water surface left untreated in accordance with the present invention, that is, toward a new path 178 resulting from the steering of the hurricane 112.

As with the prior embodiment, lots of approximately 10,000, small wave-powered pumps 118 (about 50 gallon (189.3 liters) cylinder size) are positioned and deployed in multiple lots of approximately 1 pump per square mile (2.59 square kilometers) over 100 miles squared (25,900 square kilometers) ahead of the projected path 176 of a hurricane 112 to either the left or the right side of the hurricane's projected path 176 depending upon the direction one desires steer the hurricane 112.

Considering the application of the present system to Hurricane Mitch 1998, which was a Category 5 hurricane with 180 MPH (289.7 kilometers/hour) winds when it hit Central America, it is believed the present system would have mitigated the overall damage.

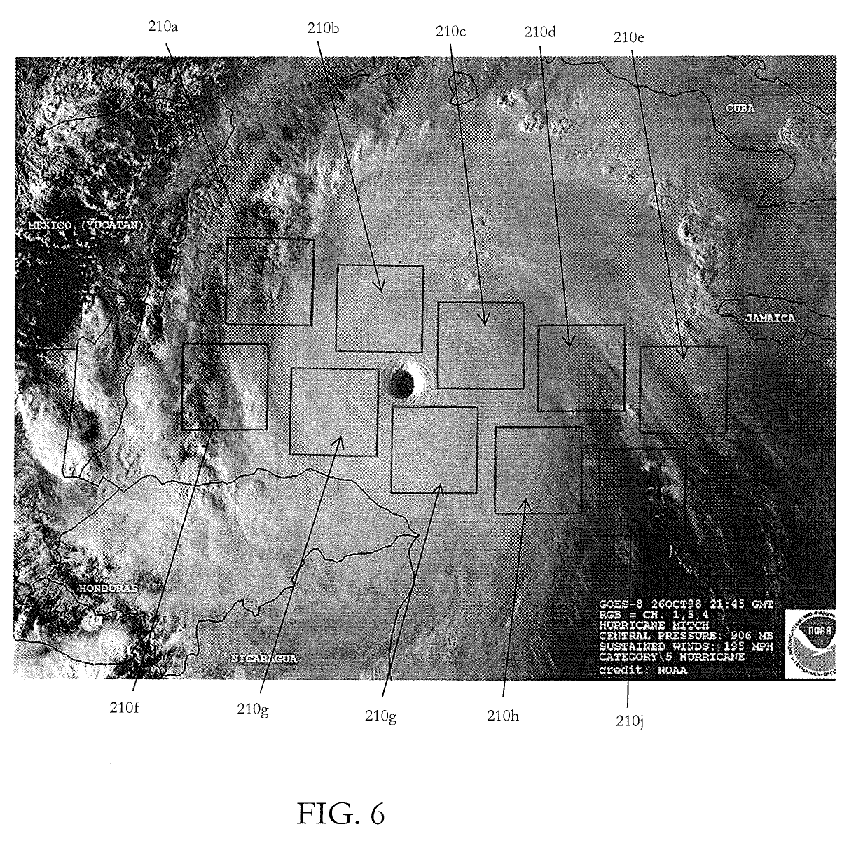

It is estimated that Hurricane Mitch picked up 2 billion tons of water per day. Compare this with the present system employing wave-powered pumps, which could deliver maybe 30 million tons (27,215,542 metric tons) of 10° Fahrenheit (5.55° Celsius) cooler water (comparing the surface temperature of the water to water drawn from a predetermined depth as shown with reference to the chart above showing temperature changes at different water depths) per day, per 10,000 wave-powered pumps deployed, or 300 million tons (272,155,422 metric tons) if ten deployments are employed in accordance with the present invention. Referring to FIG. 6, each square is about 100 miles (160.9 kilometers) across, and represents the potential positioning of multiple lots 210a-j of 10,000 wave-powered pumps in accordance with the present invention. While it should be appreciated the actual deployment of water-powered pumps would not be necessarily be in neat squares, but dispersed throughout the area, the diagram shown in FIG. 6 provides a rough idea of what might be possible through the implementation of the present system in a large hurricane like Hurricane Mitch.

The calculation of 300 million tons (272,155,422 metric tons) of 10° Fahrenheit cooler water per day was determined in the following manner: 10,000 fifty gallon (189.3 liters) wave-powered pumps deliver 500,000 gallons (1.89×10⁶ liters) per wave. With 10 waves per minute, that is, 5,000,000 gallons (1.89×10⁷ liters) per minute, or 300,000,000 gallons (1.14×10⁹ liters) per hour (multiply the gallons (liters) per minute by 60 minutes in an hour), or 7,200,000,000 gallons (2.73×10¹⁰ liters) per day. Considering that each gallon weighs approximately 8 pounds (3.63 kilograms), this equals 57,600,000,000 pounds (2.61×10¹⁰ kilograms) of water per day. Divide this by 2,000 pounds (9.72 kilograms) per ton and the result is about 30 million tons (27,215,542 metric tons) of water per day for 10,000 wave-powered pumps, or 300 million tons (272,155,422 metric tons) per day if ten deployments (that is, 100,000 wave-powered pumps) are possible in the hurricane area.

300 million tons (272,155,422 metric tons) of water is about 15% of the water picked up by Mitch per day. Many variables are involved, but potentially this could have the effect of a 1.5° Fahrenheit (0.83° Celsius) cooler sea surface temperature, that is, cooler water body/hurricane interface zone 14 (15% of 10° Fahrenheit (5.55° Celsius)). It is contemplated a temperature drop of approximately 1° Fahrenheit (0.55° Celsius) up to approximately 10° Fahrenheit (5.55° Celsius) along the water body/hurricane interface zone 14 might be possible. However, and although a 1° Fahrenheit (0.55° Celsius) up to 10° Fahrenheit (5.55° Celsius) temperature drop along the water body/hurricane interface zone 14 is discussed herein in accordance with a preferred embodiment, ultimately a cost-benefit analysis would be required to determine the extent of cooling warranted. As discussed below, it might be possible to reduce the energy of a Category 5 hurricane by as much as approximately 33% with only a 1.5° Fahrenheit (0.83° Celsius) drop in temperature along the water body/hurricane interface zone 14, which would certainly require less expense in the implementation of the present invention.

While the potential effect of this is not entirely clear, there is a generally agreed upon rule that hurricanes gain strength with sea surface temperatures, that is, water body/hurricane interface zone 14 above 80° Fahrenheit (26.66° Celsius), and lose strength with sea surface temperatures below 80° Fahrenheit (26.66° Celsius). The reason why 80° Fahrenheit (26.66° Celsius) is such a “break-even” point is not entirely clear, but it is estimated that below 80° Fahrenheit (26.66° Celsius), the wind at the base of the hurricane doesn't pick up enough heat (energy) to rise high enough to keep the dynamic indicated in FIG. 2 going.

FIG. 2 indicates a dynamic where hurricanes form when the energy released by the condensation of moisture in rising air causes a chain reaction. The air heats up, rising further, which leads to more condensation. The air flowing out of the top of this “chimney” drops toward the ground, forming powerful winds.

Introducing cooler air at the base of the hurricane should short-circuit the dynamic described in the FIG. 2, reducing the force of the hurricane. Assuming a sea surface temperature of 85° Fahrenheit (29.44° Celsius) for Hurricane Mitch, reducing the effect of 85° Fahrenheit (29.44° Celsius) by 1.5° Fahrenheit (0.83° Celsius) should reduce the effect to the equivalent of an 83.5° Fahrenheit (28.61° Celsius) sea surface temperature. This is approximately a 33% reduction, which very roughly should reduce the strength of the hurricane by about 33%. This would reduce a hurricane like Hurricane Mitch from a Category 5 with 180 MPH (289.7 kilometers/hour) winds to a Category 3 with 120 MPH (193.1 kilometers/hour) winds, still a dangerous hurricane, but far less destructive than a Category 5 hurricane. Deployment of 100,000 wave-powered pumps against smaller hurricanes than Hurricane Mitch should have far more dramatic effects.

It should be appreciated, that so far this analysis assumes the use of only air-delivered wave powered pumps, but in areas within the continental shelf this could be supplemented by ship-delivered anchored wave-powered pumps, and also supplemented by hydraulic powered pumps in the coastal areas. This analysis also assumes that only about 110 C-130 type aircraft are used because this appears to be a practical limit of suitable aircraft types that are actually available.

The Air Force, Air Reserves and National Guard actually have over 500 C-130 s. With many other world-wide commitments, certainly all of them could not be made available for hurricane abatement, but conceivably 220 might, and this could double the effect indicated in this analysis, potentially reducing a hurricane like Hurricane Mitch to a relatively mild Category 1 hurricane. It is contemplated that one would not want to reduce a hurricane below Category 1, both because the cost of doing so is probably greater than the damage that a Category 1 hurricane would inflict, and because hurricanes bring valuable rainfall to land.

It is contemplated one employing the present system could certainly double the number of wave-powered pumps deployed without violating the one per square mile assumption, which is likely undesirable because a law of diminishing returns will come into play if the wave-powered pumps are placed too closely together. It is estimated that hurricane force winds will easily blow spray from a wave-powered pump a mile downwind, so you probably don't want the wave-powered pumps closer than that, or they would interfere with each other. Plus, assuming the accuracy of the present analysis, one probably would not need more than one wave-powered pump per square mile.

Thinking further ahead, there is probably a better aircraft design for this mission than the C-130, which is only recommended here because sufficient C·130 s are actually available at the present time. It is contemplated a more efficient design should be able to deliver more wave-powered pumps at lower cost. A C-5A/B aircraft could hold 360 wave-powered pumps, as opposed to a C-130 holding only 45, so (with 2 missions a day) only about 28 C-5A/Bs would be needed to deliver about 20,000 wave-powered pumps a day. But things like the pressurized upper decks of the C-5A/B would be wasted on this mission. The present system does not require the high altitude capability of the C-5A/B and the present system also does not require the higher speeds of jets. Plus only 81 C-5A/Bs were built, and it's unlikely that 28 could be dedicated for hurricane abatement so that won't solve the additional capacity problem, if 20,000 wave-powered pumps a day are needed. If about 84 aircraft of a better design for this mission were built, coverage could be extended to typhoons and cyclones in the Western Pacific and Indian Oceans and the new aircraft could supplement Air Force transport requirements in hurricane off-seasons.

The present system provides a practical and cost-effective way to provide for hurricane abatement. It's also environmentally sound, because the present system does not do anything that a hurricane wouldn't do anyway, because by wave action a hurricane brings cooler water to the surface anyway.

While the present disclosure focuses upon a single application along the path of a hurricane, the process of positioning pumps along the path of a hurricane may be repeated as needed several times as the hurricane advances. As with the prior embodiment, the pumps are preferably ship delivered before the hurricane season and anchored within the continental shelf in areas likely to be in the track of the hurricane or the pumps are air dropped along the hurricane path at locations approximately 24 hours ahead of the predicted path of the hurricane. Regardless of whether the pumps are ship delivered, air dropped, or otherwise delivered to their desired locations, environmental impact is reduced by only using the pumps during hurricane season and then recovering the pumps.

While the preferred embodiments have been shown and described, it will be understood that there is no intent to limit the invention by such disclosure, but rather, is intended to cover all modifications and alternate constructions falling within the spirit and scope of the invention.

1. A system for hurricane abatement which cools air above a water body surface of a water body, comprising:
a large number of relatively small pumps dispersed over a wide area of the water body, the pumps being shaped and dimensioned for pumping water from a depth of the water body into the air above the water body surface thereby cooling the air above the water body surface;
the pumps being deployed in lots of approximately 1 pump per square mile (2.59 km²) over a 100 miles squared (25,900 km²) area ahead of a projected path of a hurricane.

2. The system according to claim 1, wherein the pumps are wave-powered pumps.

3. The system according to claim 2, wherein each of the wave-powered pumps is composed of an extending tube and a pressure cylinder, the extending tube and the pressure cylinder interacting with assistance of wave motion to pressurize water held within the extending tube and pump water out of a dispensing end and into the air above the water body surface.

4. The system according to claim 3, wherein the extending tube includes a lower, first end which is positioned at a desired depth within the water body and an upper, second end from which pressurized water is pumped upwardly into the atmosphere above the water body surface.

5. The system according to claim 4, wherein the first end of the extending tube includes a down weight for holding the extending tube at a desired location within the water body.

6. The system according to claim 4, wherein the first end of the extending tube includes a filter.

7. The system according to claim 4, wherein the extending tube includes an inflatable tube adjacent the second end supporting the second end of the extending tube above the water body surface.

8. The system according to claim 7, wherein the second end of the extending tube includes a stand pipe and a nozzle.

9. The system according to claim 3, wherein the extending tube includes piston rod and the pressure cylinder interacts therewith for creating pressure causing dispensing of water from the second end of the extending tube.

10. The system according to claim 9, further including a piston that is fixedly secured to the piston rod at a central position along the piston rod, the piston being shaped and dimensioned for positioning within a central cavity defined by the pressure cylinder.

11. The system according to claim 1, further including a permanent pumping system composed of a land-based pumping station linked to a plurality of spray assemblies defining passageways for forcing water upwardly to the water body surface where it is sprayed into the air directly above the water body surface.

12. The system according to claim 11, wherein each of the spray assemblies includes a hose to which an inflatable member is positioned at a distal end thereof such that a spray nozzle at a second end of the hose sits above the water body surface for spraying water to a desired height above the water body surface.

13. The system according to claim 1, wherein water is sprayed to a height of about 30 feet (9.144 meters) into the air.

14. The system according to claim 1, wherein the spray of water reduces air temperature in the air directly above the water body surface by approximately 1° Fahrenheit (0.55° Celsius) to 10° Fahrenheit (5.55° Celsius).

15. A method for hurricane abatement, comprising the following steps:
determining requirements necessary to properly abate a hurricane;
pumping water from depths of a water body into an area directly above a water body surface of the water body and along a projected path of the hurricane, thereby cooling air along a path of the projected path of the hurricane;
diminishing power of the hurricane as it passes through the cooled air above the water body surface.

16. The method according to claim 15, wherein the step of pumping includes spraying the water to a height of about 30 feet (9.14 meters) into the air.

17. The method according to claim 15, wherein the spray of water reduces air temperature in the air directly above the water body by approximately 1° Fahrenheit (0.55° Celsius) to 10° Fahrenheit (5.55° Celsius).

18. The method according to claim 15, further including the step of positioning a plurality of multiple lots of approximately 1 pump per square mile (2.59 square kilometers) over a 100 miles squared (25,900 square kilometers) area ahead of the projected path of the hurricane.

19. The method according to claim 18, wherein the step of pumping includes spraying the water to a height of about 30 feet (9.14 meters) into the air.

20. The method according to claim 19, wherein the spray of water reduces air temperature in the air directly above the water body by approximately 1° Fahrenheit (0.55° Celsius) to 10° Fahrenheit (5.55° Celsius).

21. The method according to claim 18, wherein the step of positioning includes delivering the pumps via aircraft.

22. The method according to claim 18, wherein the pumps are wave-powered pumps.

23. The method according to claim 18, wherein the pumps are powered by a permanent land-based pumping system.

24. The method according to claim 15, further including the step of steering the hurricane.

25. The method according to claim 24, wherein the step of steering includes cooling the air directly above the water body surface at positions to the left or the right of the projected path of the hurricane.
